(19) United States
(12) Patent Application Publication
(10) Pub. No.: US 2005/0229655 A1
(43) Pub. Date: Oct. 20, 2005

(54) Storage device for safety check media of baggage case

(76) Inventor: Chun-Te Yu, Fu-Hsing Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/942,841

(22) Filed: Sep. 17, 2004

(30) Foreign Application Priority Data
Apr. 14, 2004 (TW) 93205768

(51) Int. Cl. E05B 65/52

(52) U.S. Cl. 70/63; 70/284; 70/285

(57) ABSTRACT

A storage device for safety check media of baggage case, including a cartridge disposed on the baggage case which is locked by at least a numeral lock and a key-driven lock. The cartridge has an internal receiving space. At least a mark unit is previously disposed in the receiving space for showing a correct unlocking number of the numeral lock of the baggage case. In addition, a key for unlocking the key-driven lock of the baggage case is further placed in the receiving space. A key-driven lock is disposed on the cartridge, which key-driven lock is only unlockable with a safety check general key provided by lock manufacturer. The storage device is especially applicable to a baggage case equipped with at least two types of locks. The storage device enables a safety checker to more quickly and conveniently perform security checking operation without damaging the locks of the baggage case.

### BACKGROUND OF THE INVENTION

The present invention is related to a storage device for safety check media of baggage case. The storage device is integrally disposed on a baggage case, enabling a safety checker to quickly have the unlocking media to unlock the locks of the baggage case for checking the contents therein.

A conventional baggage case is equipped with a lock for preventing the contents in the baggage case from missing or being stolen. The lock can be directly disposed on the baggage case by a manufacturer or purchased and additionally mounted on the baggage case by a user.

The above locks include key-driven type and numeral type. Only when a correct is key is inserted into the lock or the numeral wheels of the lock are turned to a correct number, the lock can be unlocked.

When traveling abroad, the baggage case will be checked by customs workers to ensure safety. Nowadays, the check is executed more strictly to avoid terrors. For example, the travelers are required by U.S. customs to unlock the locks of the baggage cases themselves, whereby the customs workers can open the baggage cases to check the contents as necessary. In the case that the baggage cases are not previously unlocked, the customs workers are authorized by U.S. government to forcedly break off the lock of the baggage cases to open the same for checking the contents. The damaged lock will be a loss of the user and will lead to trouble and inconvenience to the user. In order to improve the above situation, the lock manufacturers will provide a general key for the customs to unlock all the locks of similar modes. However, when encountering the numeral type lock, it will be impossible for the customs workers to conveniently unlock the lock for safety check.

### SUMMARY OF THE INVENTION

It is therefore a primary object of the present invention to provide a storage device for safety check media of baggage case. The storage device enables a safety checker to conveniently unlock various types of locks of the baggage case for checking the contents therein.

According to the above object, the storage device for safety check media of baggage case of the present invention includes a cartridge disposed on the baggage case which is locked by both a numeral lock and a key-driven lock. The cartridge has an internal receiving space. At least a mark unit is previously disposed in the receiving space for showing a correct unlocking number of the numeral lock of the baggage case. In addition, a key for unlocking the key-driven lock of the baggage case is further placed in the receiving space. A key-driven lock is disposed on the cartridge, which key-driven lock is only unlockable with a safety check general key provided by lock manufacturer.

In the above storage device, the cartridge is directly fixedly disposed on the body of the baggage case. A movable cartridge cover is assembled with the cartridge.

In the above storage device, the mark unit previously disposed in the receiving space includes a row of marked numeral wheels showing the correct unlocking number of the numeral lock.

In the above storage device, the cartridge is detachable from the baggage case. In normal state, the cartridge is locked in a corresponding receptacle of the baggage case by a lock which can be unlocked by the general key.

The present invention can be best understood through the following description and accompanying drawings wherein:

### BRIEF DESCRIPTION OF THE DRAWINGS

FIG. 1 is a perspective view of a preferred embodiment of the present invention;

FIG. 2 is a partially enlarged view of the present invention according to FIG. 1;

FIG. 3 is a view according to FIG. 2, in which the cartridge cover is opened;

FIG. 4 is a sectional view according to FIG. 2;

FIG. 4A is a sectional taken along line A-A of area B of FIG. 4;

FIG. 5 is a sectional view of another embodiment of the present invention, which has another type of linking member;

FIG. 6 is a perspective view of still another embodiment of the present invention, in which the mark unit is a mark card;

FIG. 7 is a perspective view of still another embodiment of the present invention, in which the cartridge is detachable from the baggage case; and

FIG. 8 shows that the cartridge of FIG. 7 is opened.

### DETAILED DESCRIPTION OF THE PREFERRED EMBODIMENTS

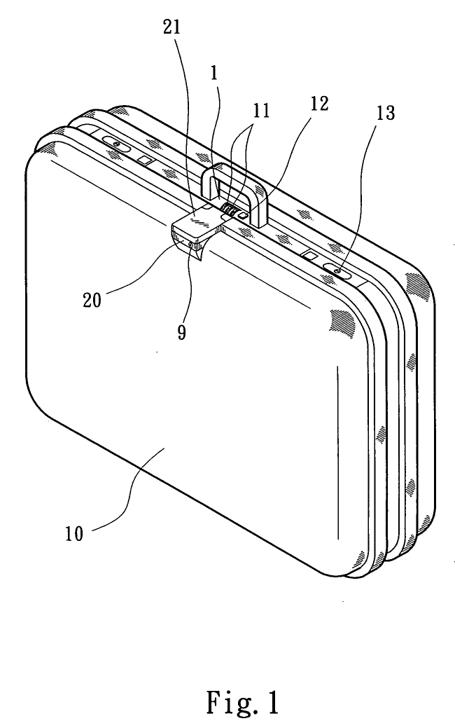

Please refer to FIG. 1. The present invention is applied to a baggage case 10 having a numeral lock composed of a row of numeral wheels 11. A press button 12 is disposed beside the numeral lock. When the numeral wheels 11 are turned to a correct unlocking number, the press button 12 can be pressed to unlock the numeral lock. In this embodiment, the baggage case 10 is equipped with a numeral lock 1 and a key-driven lock 13.

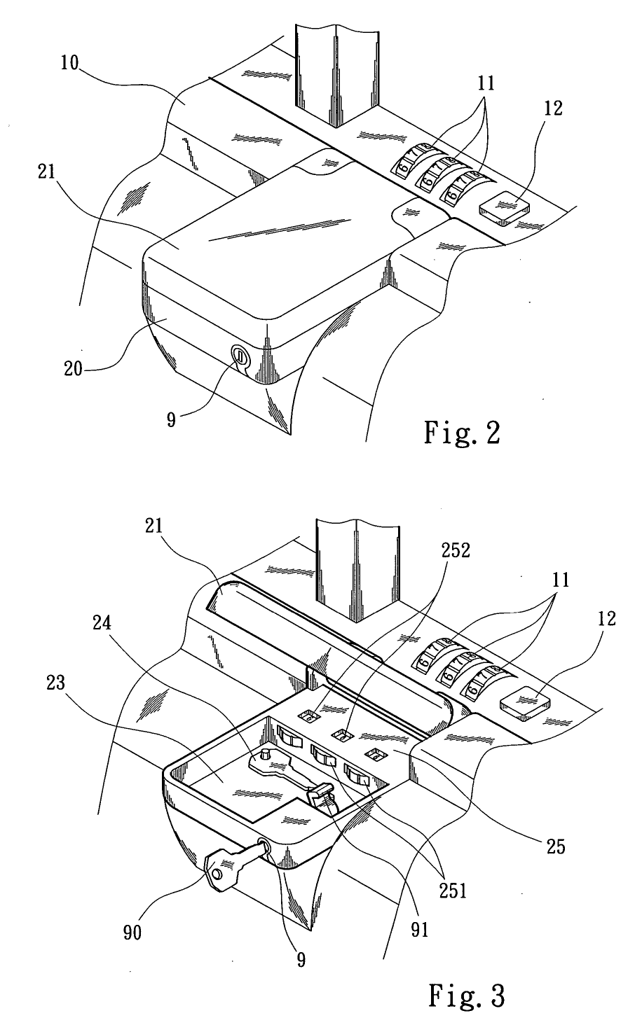

Referring to FIGS. 2 and 3, a cartridge 20 is fixed on the baggage case 10. The cartridge 20 has an internal receiving space 23 and a key-driven lock 9. Only a general key 90 provided by a lock manufacturer can be used to unlock the key-driven lock 9. A mark unit is previously disposed in the receiving space 23 for showing the correct unlocking number of the numeral lock of the baggage case 10.

The cartridge 20 is integrally fixedly formed on the body of the baggage case. A movable cartridge cover 21 is assembled with the cartridge 20. A keyhole 22 is formed on outer end face of the cartridge 20.

After the movable cartridge cover 21 is opened with the general key 90, the mark unit in the receiving space 23 is shown. In addition, a key 24 for unlocking the key-driven lock 13 of the baggage case can be previously placed in the receiving space 23.

In this embodiment, the mark unit 25 previously disposed in the receiving space 23 includes a row of marked numeral wheels 251 showing the correct unlocking number through windows 252 or on the rims.

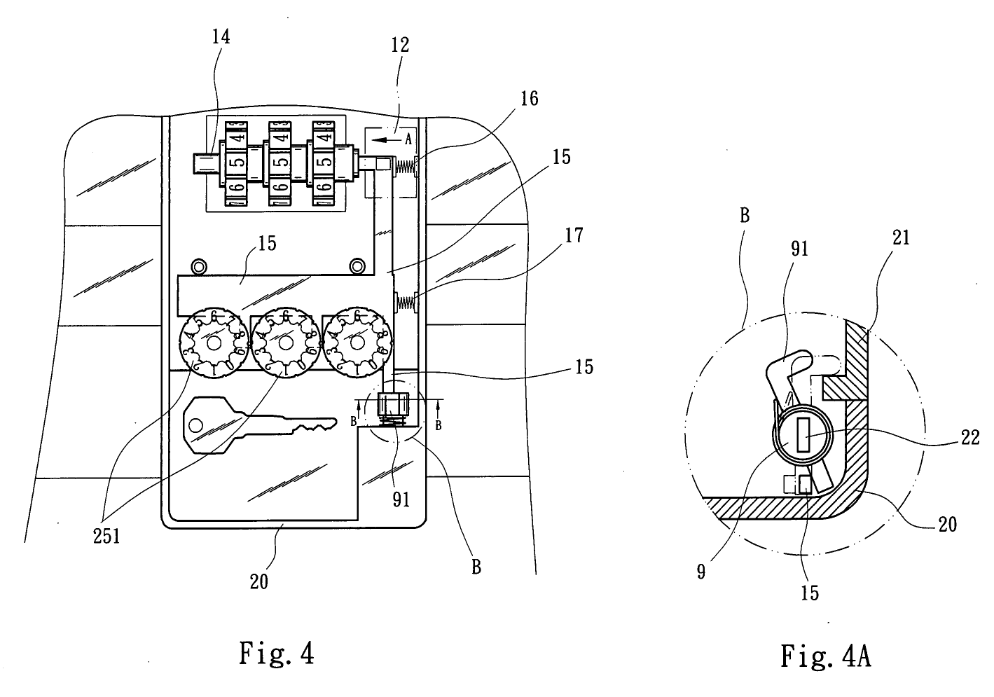

Referring to FIG. 4, due to incautious touch, the numeral wheels 251 of the mark unit 25 may be unexpectedly turned into a random code. In order to avoid this, when a user turns the numeral wheels 11 of the numeral lock to a correct unlocking number, the press button 12 can be pressed in a direction of arrow A. At this time, the lock core 14 of the numeral lock is driven to unlock the numeral lock. A linking member 15 is linked with the press button 12. When unlocked, the linking member 15 is synchronously moved with the press button 12, that is, transversely moved to left side. At this time, the marked numeral wheels 251 in the receiving space 23 are released. At the same time, a latch hook 91 for locking the cartridge cover 21 is released. Reversely, after the press button 12 is released from the pressing force, resilient members 16, 17 restore the lock core 14 and the linking member 15 to their home positions into a locked state.

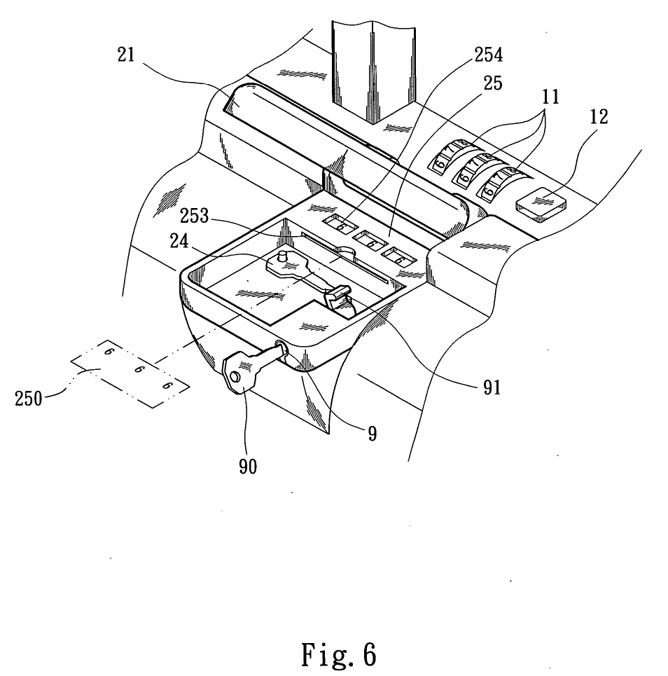

FIG. 6 shows another embodiment of the present invention, in which the mark unit is a mark card 250 inserted in an insertion slot 253 in the receiving space 23. The insertion slot 253 has windows 254 for showing the correct unlocking number. Therefore, the unlocking number can be shown without extracting the mark card 250 out of the insertion slot 253.

One end of the cartridge cover 21 is pivotally connected with the cartridge, while the other end of the cartridge cover 21 is a movable end. After the general key 90 is inserted into the keyhole of the key-driven lock 9, the latch hook 91 is driven. In natural state, the latch hook 91 locks the cartridge cover 21. When the general key 90 is turned, the latch hook 91 is biased to release the cartridge cover 21, permitting a safety checker to open the cartridge cover 21.

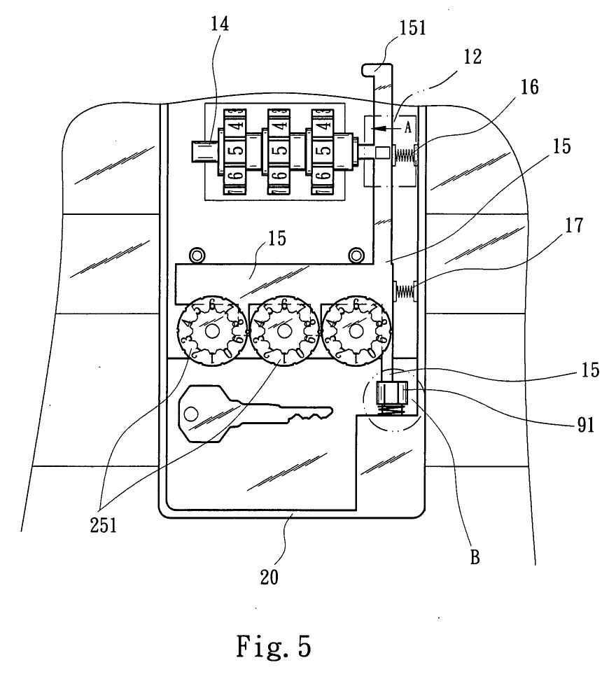

Referring to FIG. 5, a lock latch 151 extends from the linking member 15 to serve as a baggage lock for locking the baggage case 10.

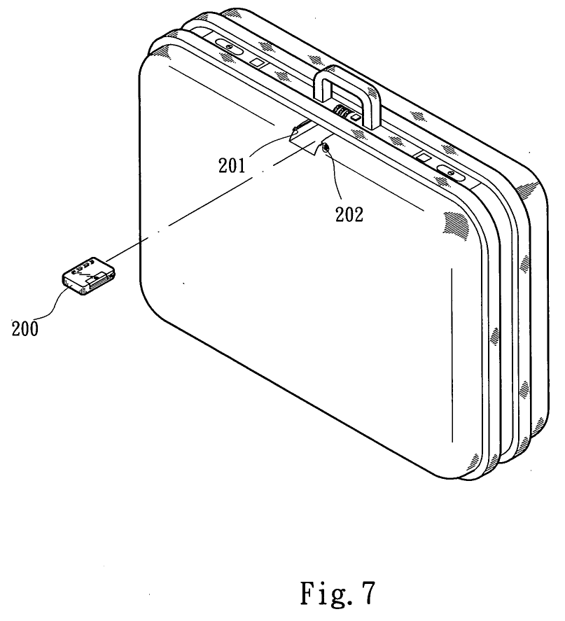

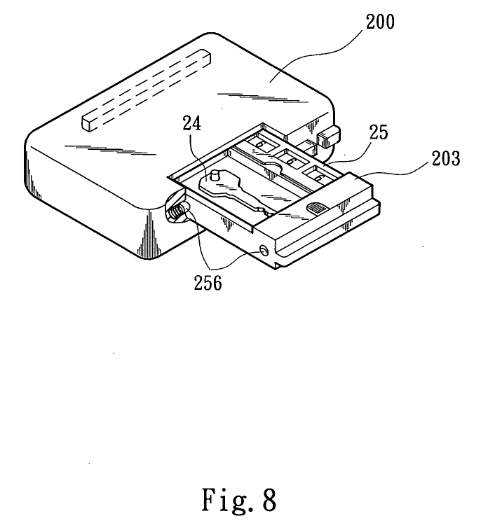

FIGS. 7 and 8 show still another embodiment of the present invention, in which the cartridge 200 is detachable from the baggage case. In normal state, the cartridge 200 is locked in a corresponding receptacle 201 of the baggage case by a lock 202. The lock 202 can be unlocked by the general key 90. After the lock 202 is unlocked with the general key 90, the cartridge 200 can be taken out as shown in FIG. 7. Also, the cartridge 200 can be controlled by means of locking/unlocking the numeral lock 11. In this embodiment, the cartridge 200 has a drawer 203. The drawing/pushing travel of the drawer 203 is controlled by a locating unit 256. The locating unit 256 includes dents 204 formed on front and rear ends of the drawer 203 and a spring 205 and a steel ball 206 disposed on the cartridge 200 corresponding to the dents.

According to the above arrangement, the present invention is applicable to various baggage cases with different types of locks. The present invention enables a safety checker to more quickly and conveniently perform security checking operation.

The above embodiments are only used to illustrate the present invention, not intended to limit the scope thereof. Many modifications of the above embodiments can be made without departing from the spirit of the present invention.

1. A storage device for safety check media of baggage case, comprising a cartridge disposed on the baggage case which is locked by at least a numeral lock and a key-driven lock, the cartridge having at least one internal receiving space, at least a mark unit being previously disposed in the receiving space for showing a correct unlocking number of the numeral lock of the baggage case, a numeral lock and a key-driven lock being disposed between the cartridge and the baggage case for respectively opening/closing the cartridge, the numeral lock cooperating with a control member in controlling opening/closing of the cartridge, the key-driven lock being only unlockable with a safety check general key.

2. The storage device for safety check media of baggage case as claimed in claim 1, wherein a key for unlocking the key-driven lock of the baggage case is further placed in the receiving space.

3. The storage device for safety check media of baggage case as claimed in claim 1, wherein the cartridge is directly fixedly disposed on the body of the baggage case, a movable cartridge cover being assembled with the cartridge, the movable cartridge cover being openable only with a general key.

4. The storage device for safety check media of baggage case as claimed in claim 2, wherein the cartridge is directly fixedly disposed on the body of the baggage case, a movable cartridge cover being assembled with the cartridge, the movable cartridge cover being openable only with a general key.

5. The storage device for safety check media of baggage case as claimed in claim 1, wherein the mark unit previously disposed in the receiving space includes a row of marked numeral wheels showing the correct unlocking number of the numeral lock.

6. The storage device for safety check media of baggage case as claimed in claim 2, wherein the mark unit previously disposed in the receiving space includes a row of marked numeral wheels showing the correct unlocking number of the numeral lock.

7. The storage device for safety check media of baggage case as claimed in claim 5, wherein the numeral lock of the baggage case via a control member such as a press button controls locking of the baggage case, a linking member being connected with inner end of the control member and directed to the mark unit, the linking member being synchronously movable with the control member, whereby in a locked state, the linking member restricts the numeral wheels disposed in the receiving space from being turned.

8. The storage device for safety check media of baggage case as claimed in claim 6, wherein the numeral lock of the baggage case via a control member such as a press button controls locking of the baggage case, a linking member being connected with inner end of the control member and directed to the mark unit, the linking member being synchronously movable with the control member, whereby in a locked state, the linking member restricts the numeral wheels disposed in the receiving space from being turned.

9. The storage device for safety check media of baggage case as claimed in claim 1, wherein the control member of the numeral lock of the cartridge has an extension section extending into the receiving space, the extension section serving to drive a latch hook for unlocking the cartridge, the latch hook being also drivable by a lock core of the key-driven lock.

10. The storage device for safety check media of baggage case as claimed in claim 2, wherein the control member of the numeral lock of the cartridge has an extension section extending into the receiving space, the extension section serving to drive a latch hook for unlocking the cartridge, the latch hook being also drivable by a lock core of the key-driven lock.

11. The storage device for safety check media of baggage case as claimed in claim 1, wherein the mark unit previously disposed in the storage space is a mark card showing the correct unlocking number of the numeral lock.

12. The storage device for safety check media of baggage case as claimed in claim 2, wherein the mark unit previously disposed in the storage space is a mark card showing the correct unlocking number of the numeral lock.

13. The storage device for safety check media of baggage case as claimed in claim 11, wherein the mark card is inserted in an insertion slot formed in the receiving space.

14. The storage device for safety check media of baggage case as claimed in claim 12, wherein the mark card is inserted in an insertion slot formed in the receiving space.

15. The storage device for safety check media of baggage case as claimed in claim 13, wherein the insertion slot has windows for showing the correct unlocking number.

16. The storage device for safety check media of baggage case as claimed in claim 14, wherein the insertion slot has windows for showing the correct unlocking number.

17. The storage device for safety check media of baggage case as claimed in claim 1, wherein the cartridge is detachable from the baggage case, in normal state, the cartridge being locked in a corresponding receptacle of the baggage case by a lock which can be unlocked by the general key.

18. The storage device for safety check media of baggage case as claimed in claim 17, wherein the cartridge is detachable from the baggage case, in normal state, the cartridge being locked in a corresponding receptacle of the baggage case by a lock which can be unlocked by the general key.

19. The storage device for safety check media of baggage case as claimed in claim 5, wherein the cartridge is detachable from the baggage case, in normal state, the cartridge being locked in a corresponding receptacle of the baggage case by a lock which can be unlocked by the general key.

20. The storage device for safety check media of baggage case as claimed in claim 6, wherein the cartridge is detachable from the baggage case, in normal state, the cartridge being locked in a corresponding receptacle of the baggage case by a lock which can be unlocked by the general key.

21. The storage device for safety check media of baggage case as claimed in claim 11, wherein the cartridge is detachable from the baggage case, in normal state, the cartridge being locked in a corresponding receptacle of the baggage case by a lock which can be unlocked by the general key.

22. The storage device for safety check media of baggage case as claimed in claim 12, wherein the cartridge is detachable from the baggage case, in normal state, the cartridge being locked in a corresponding receptacle of the baggage case by a lock which can be unlocked by the general key.

23. The storage device for safety check media of baggage case as claimed in claim 17, wherein the detachable cartridge has a drawer having an internal receiving space.

24. The storage device for safety check media of baggage case as claimed in claim 18, wherein the detachable cartridge has a drawer having an internal receiving space.

25. The storage device for safety check media of baggage case as claimed in claim 19, wherein a locating unit is disposed between the drawer and the cartridge for controlling drawing/pushing travel of the drawer.

26. The storage device for safety check media of baggage case as claimed in claim 20, wherein a locating unit is disposed between the drawer and the cartridge for controlling drawing/pushing travel of the drawer.
